(19) United States
(12) Patent Application Publication
(10) Pub. No.: US 2026/0184033 A1
(43) Pub. Date: Jul. 2, 2026

(54) TOOL HOLDER CLAMP AND STORAGE

(71) Applicant: OP S.R.L., Brescia (IT)

(72) Inventor: Massimo ZILIANI, Brescia (IT)

(21) Appl. No.: 19/129,874

(22) PCT Filed: Dec. 20, 2023
(86) PCT No.: PCT/IB2023/062991

§ 371 Date: May 14, 2025

(30) Foreign Application Priority Data
Dec. 30, 2022 (IT) 102022000027327

(51) Int. Cl. B30B 15/02

(52) U.S. Cl. CPC B30B 15/028

(57) ABSTRACT

A tool-holder clamp for picking and depositing a set of tools from a tool-holder storage has a grip handle, a tool-holder disc and an identification and centering structure slidingly engaged outside the grip handle. The identification and centering structure is translatable along a clamp axis between a retracted position associated with an engagement with a first set of tools, and an advanced position associated with an engagement with a second set of tools having a different axial length with respect to an axial length of the first set of tools.

The present invention is in the technical field of radial presses, both horizontal and vertical types, for fitting hoses; in particular, a tool-holder clamp, a tool-holder storage, a tool housing and picking assembly, and a method for extracting a set of tools make up the subject matter of the present invention.

As is well known, to perform hose pressing operations, it is necessary to equip a radial press with a set of tools suitable for obtaining the desired final diameter on a hose to be subjected to pressing.

It is apparent that the set of tools with which the radial press is equipped also changes, depending on the final diameter to be obtained.

Each set of tools comprises, preferably consists of, a plurality of blocks (or tools) where the cross section of each block (or tool) is in the shape of a portion of a circular crown. Further, each block is applicable to a respective jaw. In the present case, the radial press is equipped with a plurality of jaws where a block of the set of tools is attached to each jaw of such plurality of jaws, so that the pressing force is transferred to the set of tools through the plurality of jaws.

The operations of picking and depositing the set of tools from a tool-holder storage, as well as the steps of tooling and disassembling the set of tools from the radial press, are carried out with the help of a tool-holder clamp configured to transport each block of the set of tools simultaneously.

Furthermore, each block is equipped with a pin that protrudes radially outward and is suitable for being inserted and locked in a respective seat made in the corresponding jaw when, during the tooling of the press, the jaws are commanded to close on the set of tools.

To properly mount the set of tools on the press, it is necessary to ensure the angular alignment of the tools with respect to the jaws, so that each pin may engage its respective seat, as well as the axial alignment, so that each set of tools may always be in the center of the press regardless of the length of the set of tools. It is known to the person skilled in the art that the length of the tool is a function of the diameter of the tube to be pressed.

Patent EP1610915B1, filed on behalf of the same applicant, describes a tool-holder clamp for tooling a radial press capable of ensuring both an axial and angular alignment of the set of tools during tool mounting operations on the press.

Disadvantageously, the tool-holder clamp is mechanically complex and is very bulky, as it has a long fixed pin around which a sliding pin is mounted. By adjusting the position of the sliding pin along the fixed pin, it is possible to attach set of tools of different lengths. Further, the sliding pin is at least partially housed inside the gripping handle.

To set the position of the sliding pin, a button must be pressed so as to release a stop cylinder from a transversal groove, the sliding pin must be positioned at the desired length—necessary for picking the set of tools—and the button must be released so that the stop cylinder engages the transversal groove associated with the desired length.

It is evident how the operations to adjust the length of the tool-holder clamp are extremely complex. Further, the clamp is bulky, and this bulk is attributable to the length of the fixed pin.

A further example of a tool-holder clamp according to the state of the art is described in EP3339009A1.

The object of the present invention is to propose a tool-holder clamp, a tool-holder storage, a tool housing and picking assembly, and a method for extracting a set of tools that are capable of at least partially solving the drawbacks mentioned above.

Said object is achieved with a tool-holder clamp according to claim 1, a tool-holder storage according to claim 8, a tool housing and picking assembly according to claim 12 and a method for extracting a set of tools according to claim 13.

The dependent claims describe preferred embodiments of the invention.

However, the features and advantages of the tool-holder clamp, tool-holder storage, tool housing and picking assembly, and method for extracting a set of tools according to the invention will be apparent from the description provided below of its preferred exemplary embodiments, given by way of illustration and not limitation, with reference to the attached figures, wherein:

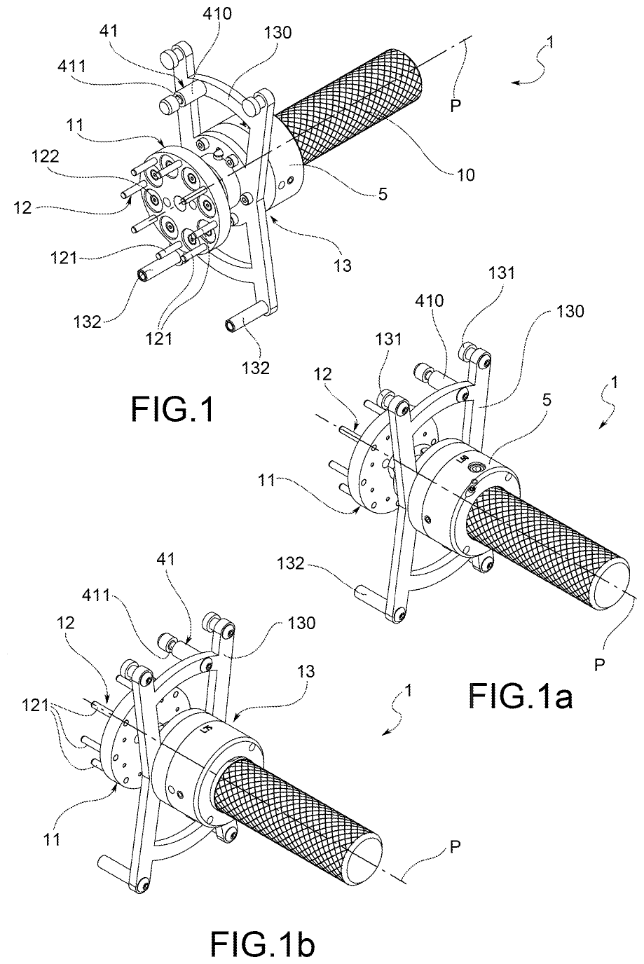

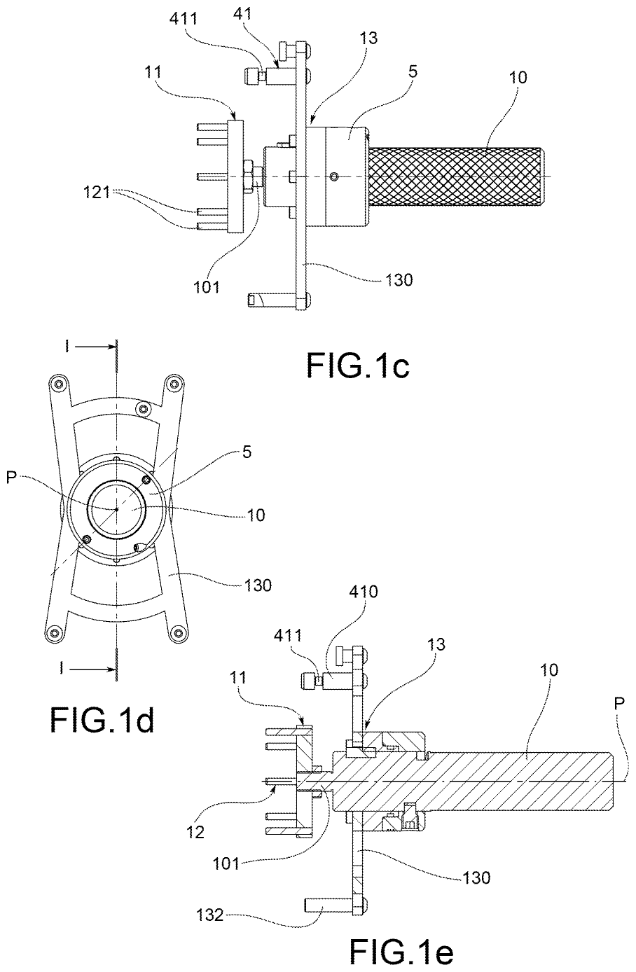

FIG. 1 is a perspective view of a tool-holder clamp in a first embodiment;

FIG. 1a is a perspective view of the tool-holder clamp in FIG. 1 according to a different angle and in a retracted position;

FIG. 1b is a perspective view of the tool-holder clamp in FIG. 1 according to a different angle and in an advanced position;

FIG. 1c is a side view of the tool-holder clamp in FIG. 1;

FIG. 1d is a rear view of the tool-holder clamp in FIG. 1;

FIG. 1e is a cross-sectional view taken along the line I-I of FIG. 1d;

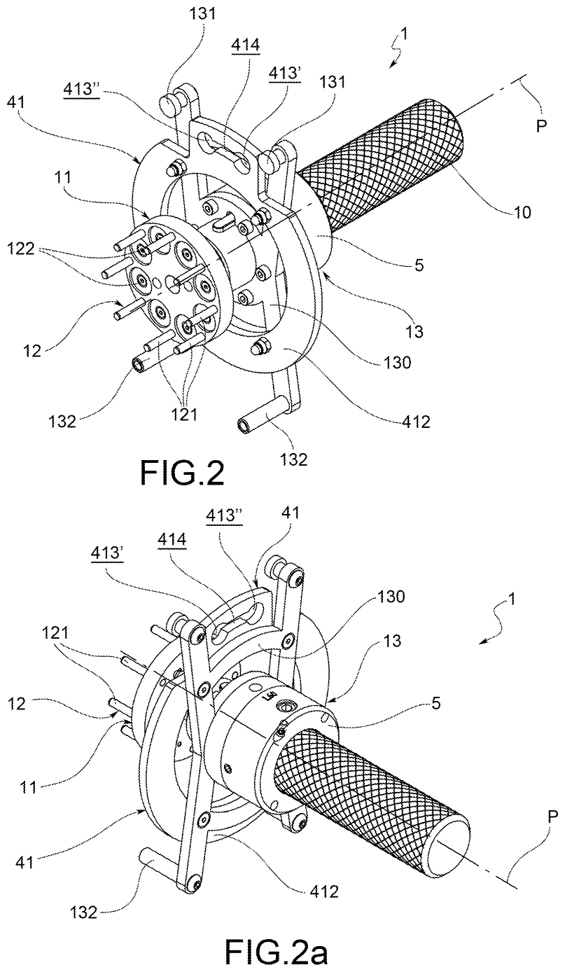

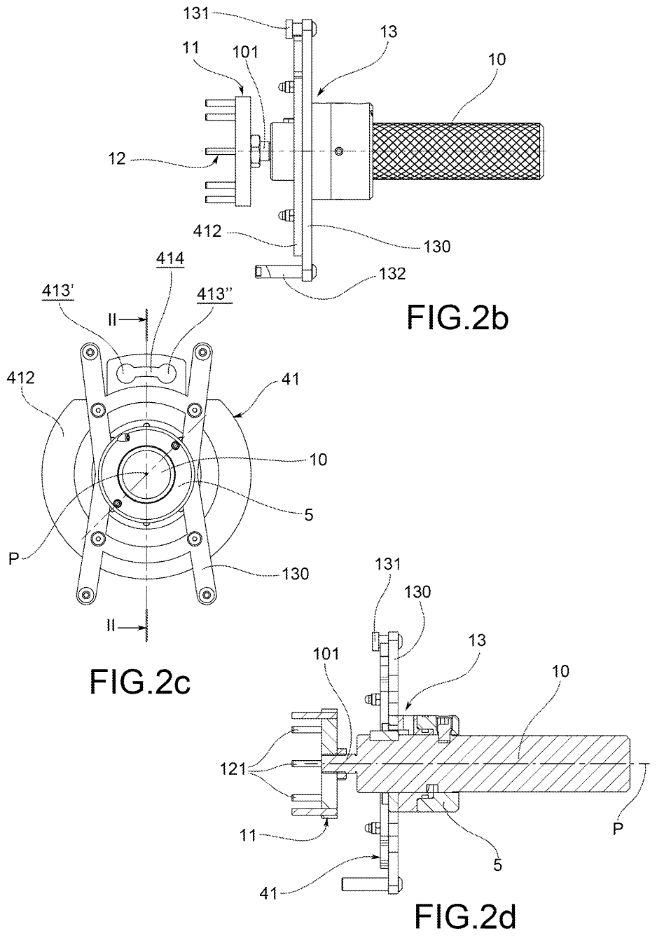

FIG. 2 is a perspective view of the tool-holder clamp in a second embodiment;

FIG. 2a is a perspective view of the tool-holder clamp in FIG. 2 according to a different angle and in a retracted position;

FIG. 2b is a side view of the tool-holder clamp in FIG. 2;

FIG. 2c is a rear view of the tool-holder clamp in FIG. 2;

FIG. 2d is a cross-sectional view taken along the line II-II of FIG. 2c;

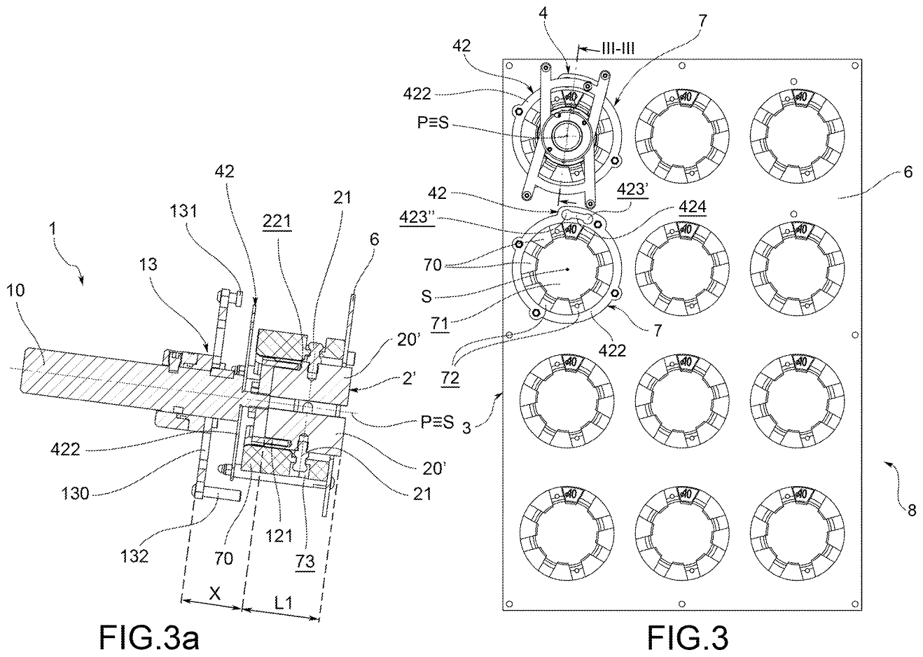

FIG. 3 is a front view of a tool housing and picking assembly in one embodiment;

FIG. 3a is a cross-sectional view taken along the line III-III of FIG. 3 and relating to the tool-holder clamp engaged with the set of tools housed in a tool-holder shell;

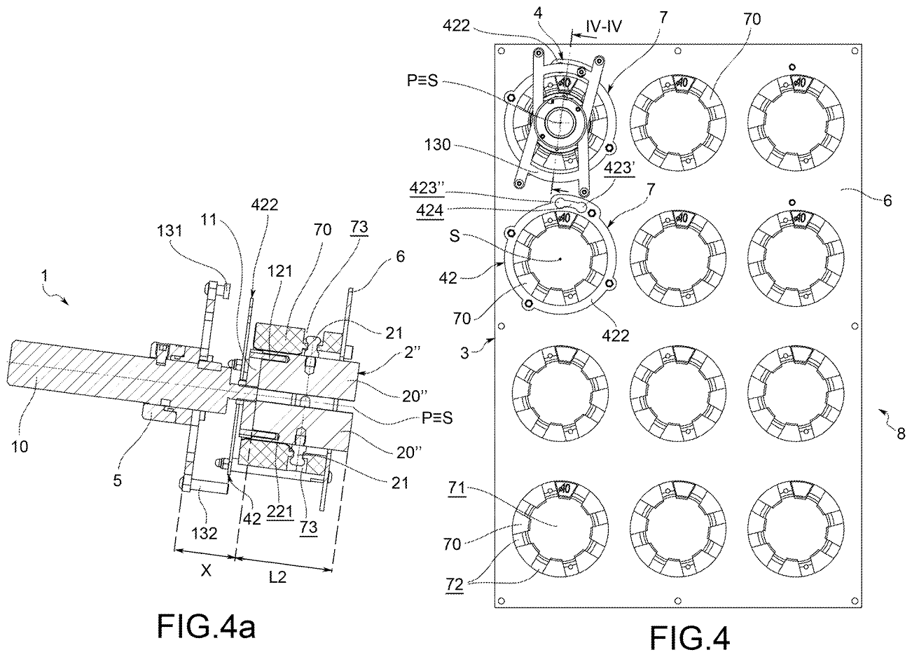

FIG. 4 is a front view of the tool housing and picking assembly in a further embodiment;

FIG. 4a is a cross-sectional view taken along the line IV-IV of FIG. 4 and relating to the tool-holder clamp engaged with the set of tools housed in the tool-holder shell;

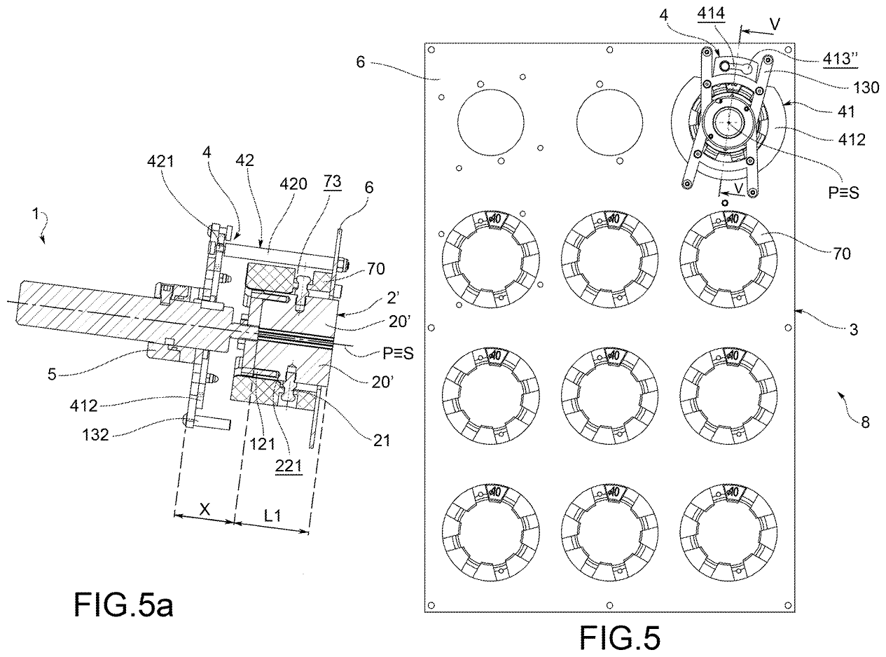

FIG. 5 is a front view of the tool housing and picking assembly in yet another embodiment;

FIG. 5a is a cross-sectional view taken along the line V-V of FIG. 5 and relating to the tool-holder clamp engaged to the set of tools housed in the tool-holder shell;

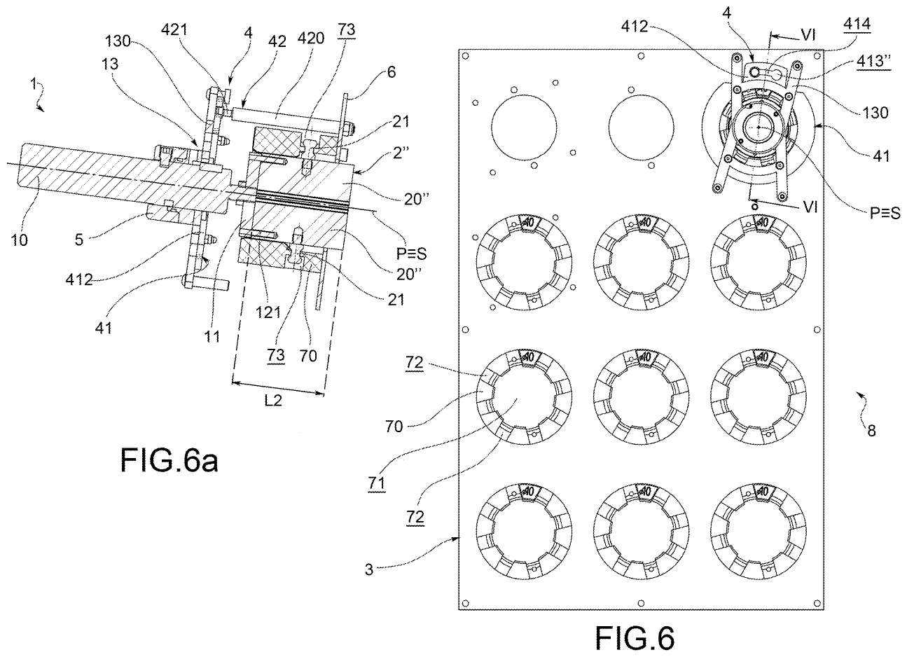

FIG. 6 is a front view of the tool housing and picking assembly in another embodiment;

FIG. 6a is a cross-sectional view taken along the line VI-VI of FIG. 6 and relating to the tool-holder clamp engaged with the set of tools housed in the tool-holder shell;

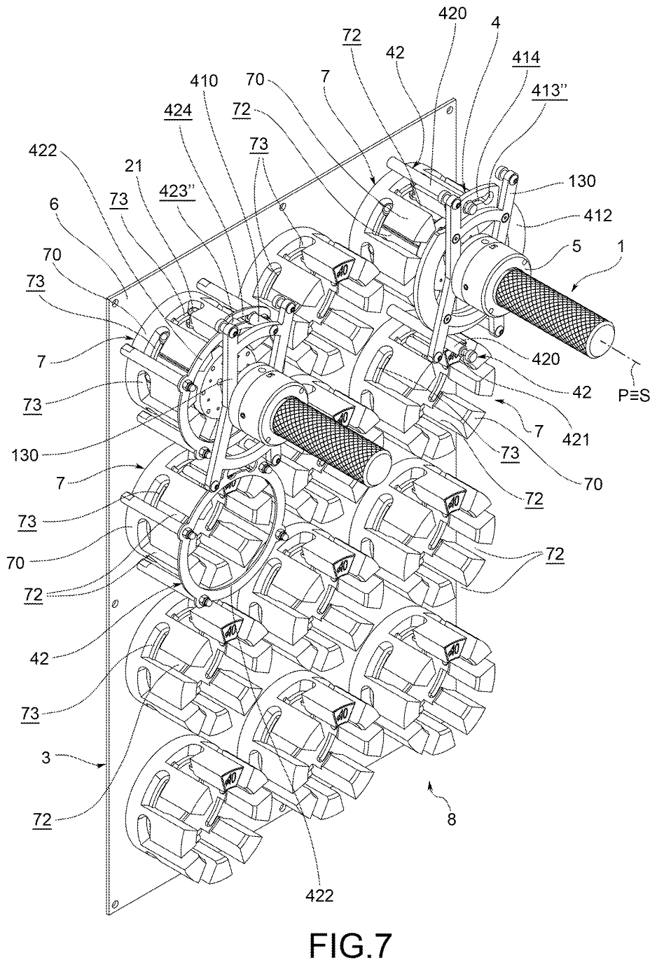

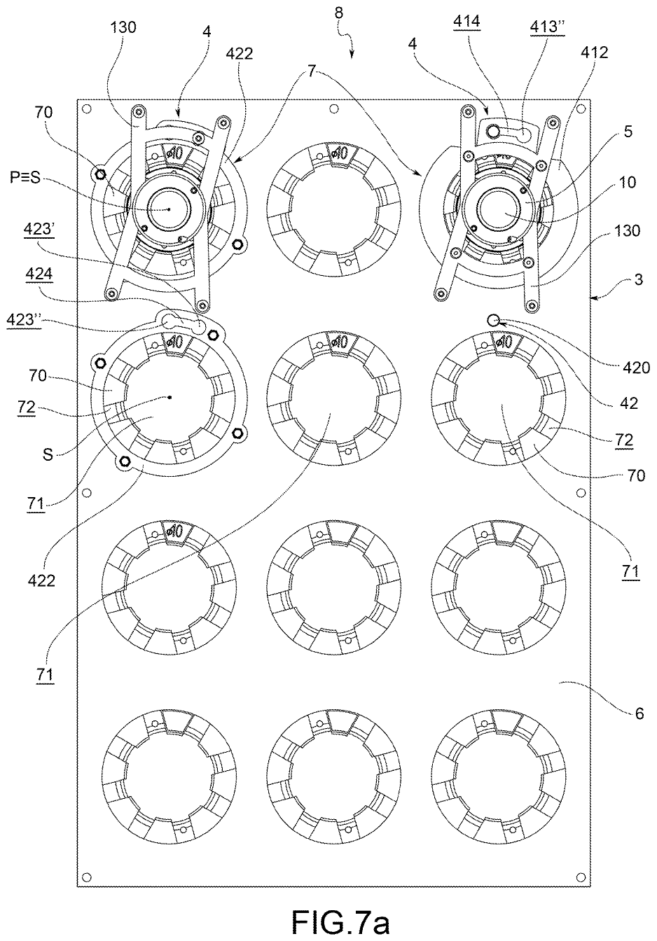

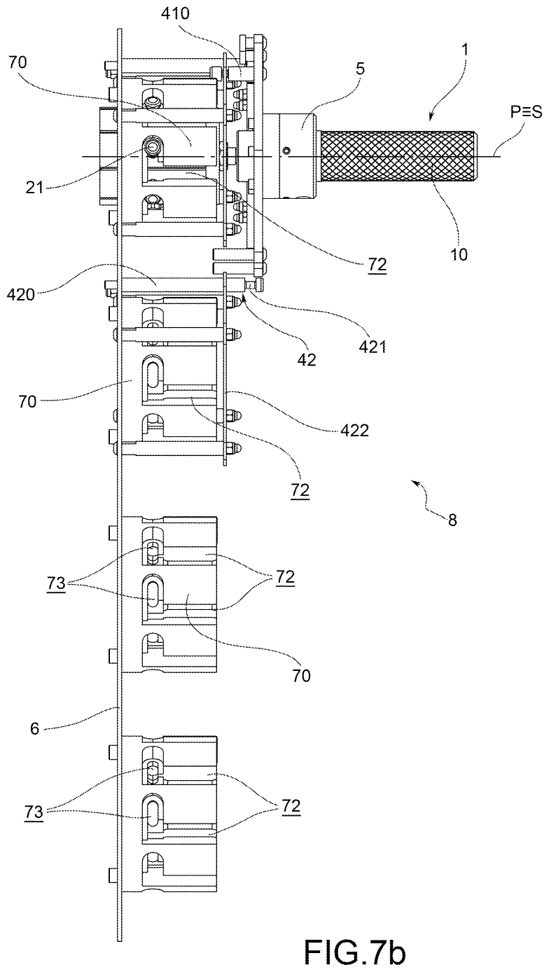

FIG. 7 is a perspective view of the tool housing and picking assembly in a yet another embodiment;

FIG. 7a is a front view of the tool housing and picking assembly in FIG. 7, and

FIG. 7b is a side view of the tool housing and picking assembly in FIG. 7.

In the following description, elements common to the various embodiments represented in the drawings are indicated with the same reference numerals.

In said drawings, the reference numeral 1 denotes a tool-holder clamp according to the invention in its entirety.

In a general embodiment, the tool-holder clamp 1 is suitable for the operations of picking and depositing a set of tools 2′; 2″ for a radial press from a tool-holder storage 3.

The tool-holder clamp 1 comprises a gripping handle 10, a tool-holder disc 11 and an identification and centering structure 13. The gripping handle 10 extends predominantly along a clamp axis P. The tool-holder disc 11 is positioned at one end of the gripping handle 10 and is provided with support means 12 suitable for supporting the set of tools 2′; 2″ in a circular arrangement. The identification and centering structure 13 is slidingly engaged outside the gripping handle 10. In particular, such an identification and centering structure 13 translates while keeping itself at least partially engaged with an outer surface of the gripping handle 10; preferably, the identification and centering structure 13 is coaxial to the gripping handle 10 and slidingly surrounds the outer surface of such gripping handle 10.

Such identification and centering structure 13 is translatable along the clamp axis P between a retracted position, associated with the engagement with a first set of tools 2′, and an advanced position associated with the engagement with a second set of tools 2″ having a different axial length with respect to the axial length of the first set of tools 2′.

Further, the identification and centering structure 13 is suitable for creating complementary coupling means 4 with the tool-holder storage 3 so that, by arranging the identification and centering structure 13 in the position compliant with the length of the set of tools 2′; 2″ to be picked, the engagement of complementary coupling means 4 is obtained so as to make the tool-holder clamp 1 engageable with the set of tools 2′; 2″. In other words, by arranging the identification and centering structure 13 in a retracted or advanced position, the tool-holder clamp 1 may achieve the axial coupling of the complementary coupling means 4.

The identification and centering structure 13 comprises centering means 41 suitable for creating complementary coupling means 4 with respective centering counter-means 42 obtained on the tool-holder storage 3. By arranging the identification and centering structure 13 in the position compliant with the length of the set of tools 2′; 2″ to be picked, the centering means 41 are configured to achieve the engagement with the respective centering counter-means (42) and thus make the tool-holder clamp 1 engageable with the set of tools 2′; 2″.

For the purposes of this discussion and unless otherwise specified, the term “axial” and the respective derivatives are thereof to be understood as referring to a direction parallel or coincident to the clamp axis P.

Preferably, the identification and centering structure 13 is positionable exclusively in a retracted or advanced position. Alternatively, there may be a plurality of intermediate positions between the retracted position and the advanced position.

Preferably, the support means 12 comprise a plurality of support pegs 121 and a plurality of support magnets 122. The plurality of support pegs 121 is arranged along a circular crown, where each support peg of such plurality of support pegs 121 is suitable for engaging a corresponding peg seat 221 obtained on each tool of the set of tools. Further, the plurality of support magnets 122 is also arranged in a circular crown, where each magnet of such plurality of magnets 122 is suitable or attaching to a respective block (or tool) of the set of tools. The engagement of the plurality of support pegs 121 and the plurality of support magnets 122 with the set of tools 2′; 2″ makes the tool-holder disc 11 suitable for stably supporting the set of tools 2′; 2″ during the operations of picking/depositing the set of tools 2′; 2″ from/into the tool-holder storage 3.

Preferably, the gripping handle 10 comprises a centering pin 101 positioned at the end where the tool-holder disc 11 is integrally engaged to the gripping handle 10. In the present case, the tool-holder disc 11 is coaxially coupled and made integral with the gripping handle 10 by means of such centering pin 101.

In one embodiment, the identification and centering structure 13 comprises a ring nut 5 sliding on the gripping handle 10. Moving the ring nut 5 on the gripping handle 10 results in the axial translation of the identification and centering structure 13; therefore, it is possible to arrange such identification and centering structure 13 in a retracted or advanced position.

Preferably, the ring nut 5 is movable along the gripping handle 10 due to the presence of a guide groove obtained in the outer surface of the gripping handle 10; such guide groove allows the rotation of the ring nut 5 to be associated with the axial translation of the identification and centering structure 13.

According to one embodiment, the identification and centering structure 13 also comprises a centering frame 130 which protrudes beyond the radial encumbrance of the tool-holder disc 11. In particular, the centering frame 130 is suitable for resting against a front surface of the radial press to ensure the angular alignment between the set of tools 2′; 2″ and respective jaws with which the radial press is equipped.

Preferably, the centering frame 130 comprises a pair of mushroom pegs 131 at the top and a pair of pins 132 at the bottom. The angular alignment of the set of tools 2′; 2″ with respect to the jaws is ensured by the engagement of the tool-holder clamp 1 with the front surface of the radial press, in particular by the engagement of the mushroom peg pair 131 and the pin pair 132 with such front surface. The terms “upper”, “lower” and their respective derivatives are intended to refer to the tool-holder clamp 1 in the operating condition.

According to one embodiment, the complementary coupling means 4 comprise centering means 41 obtained on the identification and centering structure 13. In other words, the identification and centering structure 13 comprises the centering means 41.

Further, the complementary coupling means 4 are suitable for also comprising respective centering counter-means 42 obtained on the tool-holder storage 3.

The centering means 41 and counter-means 42 are engageable with each other to allow the tool-holder clamp 1 to engage the set of tools 2′; 2″ and axially extract said set of tools 2′; 2″ from the tool-holder storage 3. In other words, the centering means 41 are engageable to the centering counter-means 42; in this way, the tool-holder clamp 1 is suitable for engaging the set of tools 2′; 2″ to axially extract such set of tools 2′; 2″ from the tool-holder storage 3.

According to one embodiment depicted in the attached FIG. 1-1e, the centering means 41 comprise a centering peg 410 provided with a lowered portion 411 and protruding axially from the identification and centering structure 13. Such lowered portion 411 is engageable to the centering counter-means 42 when the identification and centering structure 13 is in position compliant with the set of tools 2′; 2″ to be picked.

The tool-holder clamp 1 is rotatable to disengage the set of tools 2′; 2″ from the tool-holder storage 3, and the lowered portion 411 is configured to be suitable for remaining engaged with the centering counter-means 42 during the rotation of the tool-holder clamp 1.

As will be further discussed hereinafter, after having arranged the tool-holder clamp 1 in a position compliant with the set of tools 2′; 2″ to be picked, it is possible to obtain the engagement between the centering means 41 and the corresponding centering counter-means 42 with which the tool-holder storage 3 is equipped. Therefore, once the engagement between the tool-holder disc 11 and the set of tools 2′; 2″ has been achieved, and the engagement between the complementary coupling means 4 has also been achieved, the tool-holder clamp 1 is rotated and pulled to allow the set of tools 2′; 2″ to be taken out of the tool-holder storage 3. Thus, the centering means 41 are rotatable with respect to the corresponding centering counter-means 42, which instead remain fixed. The set of tools 2′; 2″, when taken out of the tool-holder storage 3, is supported by the tool-holder clamp 1 so that the tooling of the radial press may proceed.

In accordance with an embodiment depicted in the attached FIG. 2-2d, the centering means 41 comprise a centering flange 412 where a pair of holes 413′; 413″ is obtained and connected to each other by means of a groove 414 of a smaller width than that of the diameter of each hole in such pair of holes 413′, 413″. Preferably, the groove 414 is through.

The centering means 41 are engageable by centering counter-means 42 when the identification and centering structure 13 is in position compliant with the set of tools 2′; 2″ to be picked.

The tool-holder clamp 1 is rotatable to disengage the set of tools 2′; 2″ from the tool-holder storage 3 and the centering means 41 are configured to be suitable for being engaged by the respective centering counter-means 42 during the rotation of the tool-holder clamp 1.

Preferably, only as a result of the engagement between the tool-holder disc 11 and the set of tools 2′; 2″ is it possible to also obtain the engagement between the complementary coupling means 4 so that the tool-holder clamp 1 may be rotated and pulled to allow the set of tools 2′; 2″ to be extracted from the tool-holder storage 3. According to an embodiment variant, the engagement between the tool-holder disc 11 and the set of tools 2′; 2″ is simultaneous with the engagement between the complementary coupling means 4.

According to a further embodiment variant, only after obtaining the engagement between the complementary coupling means 4 is it possible to also obtain the engagement between the tool-holder disc 11 and the set of tools 2′; 2″.

According to one embodiment, the centering means 41 are made in one piece with the centering frame 130 or are fixed and made integral with such centering frame 130.

Preferably, in the embodiment wherein the centering means 41 are fixed to the centering frame 130, such attachment is obtained by bolting, welding, gluing, or by shape and/or force coupling.

In a general embodiment according to the present invention, a tool-holder storage 3 is also proposed for tooling the radial press, which comprises a support frame 6, at least one set of tools 2′; 2″ and a plurality of tool-holder shells 7.

For example, the support frame 6 comprises a bottom wall to which the plurality of tool-holder shells 7 is fixed.

The set of tools 2′; 2″ comprises a plurality of blocks 20′; 20″ with a cross section in the shape of a portion of a circular crown, where each block (or tool) of such plurality of blocks 20′; 20″ is provided with a pin 21 projecting radially outward. Further, the set of tools 2′; 2″ is engageable by the tool-holder clamp 1.

Preferably, the first set of tools 2′ has a first axial length L1 and the second set of tools 2″ has a second axial length L2, where the first axial length L1 is smaller than the second axial length L2 (L1<L2).

The plurality of tool-holder shells 7 is fixed to the support frame 6, and each tool-holder shell of such plurality of tool-holder shells 7 is configured to house the set of tools 2′; 2″. Preferably, either a first 2′ or a second set of tools 2″ may be housed in each tool shell.

Each tool-holder shell comprises a substantially cylindrical shell body 70, internally delimiting a compartment 71 wherein to house the set of tools 2′; 2″.

Longitudinal slits 72 are obtained in the shell body opening frontally, e.g., on the side opposite and distal with respect to the support frame 6, and terminating posteriorly, e.g., on the side proximal to the support frame 6, with a slot 73 inclined 90° with respect to such longitudinal slits 72. Each of these longitudinal slits 72 and the respective slot are configured to slidably accommodate the pin 21.

The tool-holder storage 3 is suitable for forming complementary coupling means 4 with the tool-holder clamp 1; in particular, the tool-holder storage 3 forms complementary coupling means 4 with an identification and centering structure 13 so that only by arranging the identification and centering structure 13 in the position compliant with the length of the set of tools 2′; 2″ to be picked is the engagement of the complementary coupling means 4 obtained so as to make the tool-holder clamp 1 engageable with the set of tools 2′; 2″. In other words, the tool-holder storage 3 may form the complementary coupling means 4 with an identification and centering structure 13 of the tool-holder clamp 1.

The engagement of the complementary coupling means 4 is external to the shell body 70, i.e., this engagement is obtained outside the compartment 71.

The tool-holder storage 3 comprises centering counter-means 42 suitable for obtaining such complementary coupling means 4 with respective centering means 41 obtained on the identification and centering structure 13 of the tool-holder clamp 1. By arranging the identification and centering structure 13 in the position compliant with the length of the set of tools 2′; 2″ to be picked, the centering counter-means 42 are configured to obtain the engagement with the respective centering means 41 and thus make the tool-holder clamp 1 engageable with the set of tools 2′; 2″. Such centering counter-means 42 are external to the shell body 70.

Preferably, each shell body 70 extends along a shell axis S that is substantially coincident with the clamp axis P when the set of tools 2′; 2″ is housed in the compartment 71, i.e., inside the tool-holder shell 7.

According to one embodiment, the complementary coupling means 4 comprise centering counter-means 42 obtained on the tool-holder storage 3. In other words, the tool-holder storage 3 comprises the centering counter-means 42.

Further, the complementary coupling means 4 are also suitable for comprising respective centering means 41 obtained on the identification and centering structure 13.

These centering means 41 and counter-means 42 are engageable with each other to enable the tool-holder clamp 1 to engage the set of tools 2′; 2″ and axially extract such set of tools 2′; 2″ from the tool-holder storage 3. In other words, the centering counter-means 42 are engageable with the centering means 41, so that the set of tools 2′; 2″ is suitable for being engaged by the tool-holder clamp 1 to be then axially extracted from the tool-holder storage 3.

Centering counter-means 42 are fixed and connected to the support frame 6 and/or shell body 70. Preferably, the centering counter-means 42 are rigidly connected and made integral with the support frame 6 (FIG. 3a, 4a, 5a, 6a).

According to one embodiment, the centering counter-means 42 are suitable for cooperating with the respective centering means 41 of the tool-holder clamp 1.

According to the attached FIGS. 3-3a and 4-4a, such centering counter-means 42 comprise a coupling flange 422 where a pair of coupling holes 423′, 423″ is obtained and connected to each other by means of a guide 424 with a smaller width that of the diameter of each coupling hole of such pair of coupling holes 423′, 423″. Preferably, the guide 424 is through.

The centering counter-means 42 are engageable by a centering peg 410 when the identification and centering structure 13 is in a position compliant with the set of tools 2′; 2″ to be picked.

Further, the centering counter-means 42 are configured to be engaged by the centering peg 410 during the rotation of the tool-holder clamp 1 to disengage the set of tools 2′; 2″ from the tool-holder storage 3.

According to an embodiment depicted in the attached FIGS. 5-5a and 6-6a, the centering counter-means 42 are suitable for cooperating with the respective centering means 41 of the tool-holder clamp 1.

Such centering counter-means 42 comprise a coupling peg 420 provided with a lowered coupling portion 421. The coupling peg 420 has a longer axial length than the tool-holder shell. The lowered coupling portion 421 is suitable for engaging the respective centering means 41 when the identification and centering structure 13 is in a position compliant with the set of tools 2′; 2″ to be picked.

The lowered coupling portion 421 is configured to remain engaged with the centering means 41 during the rotation of the tool-holder clamp 1 to disengage the set of tools 2′; 2″ from the tool-holder storage 3.

Preferably, the coupling peg 420 protrudes axially from the bottom wall of the support frame 6.

In a general embodiment of the present invention, a tool housing and picking assembly 8 comprising the tool-holder clamp 1 and tool-holder storage 3 is also proposed. Therefore, the tool-holder clamp 1 and the tool-holder storage 3 are interrelated, so that they are configured as a kind of “plug and socket.”

In particular, in the embodiment shown in the attached FIGS. 3-3a, 4-4a, 5-5a, and 6-6a, the set of tools 2′; 2″ is housed in the respective tool-holder shell 7, and the pin 21 of each block (or tool) engages the respective slot 73. Following the engagement between the tool-holder disc 11 and the set of tools 2′; 2″, the engagement between the complementary coupling means 4 may also be achieved by translation of the identification and centering structure 13. Therefore, having achieved the engagement of the tool-holder disc 11 with the set of tools 2′; 2″ and having also achieved the mutual engagement between the centering means 41 and counter-means 42, the set of tools 2′; 2″ may be extracted from the tool-holder shell 7 by rotating the tool-holder clamp 1. The rotation of the tool-holder clamp 1 involves the rotation of the centering means 41 with respect to the centering counter-means 42 and allows the pin 21 of each block to slide along the respective slot 73 so as to align with the corresponding longitudinal slit. Aligning the pin 21 along the longitudinal slit allows the tool-holder clamp to be pulled, releasing the engagement between the centering means 41 and counter-means 42, and axially extracting the set of tools 2′; 2″ from the tool-holder storage 3.

In the embodiments according to the attached FIGS. 3-3a and 4-4a, the lowered portion 411 of the centering peg 410 engages a first coupling hole 423′. During the rotation of the tool-holder clamp 1, the lowered portion 411 slides along the guide 424 and reaches a second coupling hole 423″. As a result, the set of tools 2′; 2″ may be pulled out of the tool-holder storage 3.

In the embodiment according to the attached FIG. 5-5a, the lowered coupling portion 421 of the coupling peg 420 engages a first hole 413′. When rotating the tool-holder clamp 1, the lowered coupling portion 421 slides along the groove 414 and reaches a second hole 413″. As a result, the set of tools 2′ may be extracted from the tool-holder storage 3.

In the embodiment shown in FIG. 6a, the lowered coupling portion 421 of the coupling peg 420 is not engaged in the first hole 413′ because the identification and centering structure 13 is in a retracted position and must be moved to an advanced position in order for the engagement of the complementary coupling means 4 to be obtained and the set of tools 2″ to be extracted.

Preferably, to equip a horizontal radial press, the tool-holder clamp 1 must also ensure proper axial as well as radial alignment. In fact, due to the displacement of the jaws along a horizontal axis of the press, it is also necessary to provide for an axial alignment of the pin 21 of each block with respect to the seat made in the corresponding jaw. “Axial alignment” means that each pin 21 and its respective seat must arrive at the same elevation along the horizontal axis of the press, taking into account that the pin seats move along that horizontal axis until the jaws reach a final position of complete coupling with the set of tools 2′; 2″. Therefore, the distance X between the centering frame 130 and the tool-holder disc 11 must coincide with the distance between the front surface of the press, against which the clamp abuts, and the center thereof. By adjusting the translation of the identification and centering structure 13 according to the axial length of the set of tools to be picked, the set of tools may be extracted from the storage only as a result of the engagement between the centering means 41 and counter-means 42. The engagement of the complementary coupling means 4 ensures that the space between the centering frame 130 and the tool-holder disc 11 is equal to the distance X. In this way, the axial centering of the tool pins, whatever their length, with respect to the seats in the jaws, is always obtained.

According to the present invention, a method for extracting the set of tools 2′; 2″ from the tool-holder storage 3 is also proposed. This method involves:
providing the tool housing and picking assembly 8;
   grasping the tool-holder clamp 1 and moving said tool-holder clamp close to the tool-holder storage 3 to pick the set of tools 2′; 2″ with the desired axial length for carrying out pressing operations;
      arranging the identification and centering structure 13 in the retracted position for picking a first set of tools 2′, or in the advanced position for picking a second set of tools 2″;
         engaging the tool-holder disc 11 to the set of tools 2′; 2″ to be picked;
         engaging the centering means 41 of the tool-holder clamp 1 with the respective centering counter-means 42 of the tool-holder storage 3;
         rotating the tool-holder clamp, so that the pin 21 of each block moves along the slot 73 until it aligns with the respective longitudinal slit;
         pulling the tool-holder clamp 1, so that the movement of each pin 21 along the longitudinal slit allows the extraction of the set of tools 2′; 2″ from the tool-holder shell.

According to one embodiment of the method, the following steps are also included:
obtaining the engagement between the centering means 41 of the tool-holder clamp 1 and the respective centering counter-means 42 of the tool-holder storage 3 by inserting the centering peg 410 into a first coupling hole 423′ of the pair of coupling holes 423′, 423″;
rotating the tool-holder clamp; in this way the lowered portion 411, having a smaller cross section than the cross section of the centering peg 410, slides along the guide 424 and allows the centering peg 410 to reach a second coupling hole 423″ of the pair of coupling holes 423′, 423″. The angular distance traveled by the tool-holder clamp 1 to bring the centering peg 410 from the first 423′ to the second coupling hole 423″ coincides with the angular distance traveled by the pin 21 of each block to slide along the slot 73 and align axially with the respective longitudinal slit.

According to one embodiment of the method, the following steps are also included:
obtaining the engagement between the centering means 41 of the tool-holder clamp 1 and the respective centering counter-means 42 of the tool-holder storage 3 by inserting the coupling peg 420 inside a first hole 413′ of the hole pair 413′, 413″;
rotating the tool-holder clamp 1; in this way, the lowered coupling portion 421, having a smaller cross section than the cross section of the coupling peg 420, slides along the groove 414 and allows the coupling peg 420 to reach a second hole 413″ of the pair of holes 413′, 413″. The angular distance traveled by the tool-holder clamp 1 to bring the coupling peg 420 from the first 413′ to the second hole 413″ coincides with the angular distance traveled by the pin 21 of each block to slide along the slot 73 and align axially with the respective longitudinal slit.

Innovatively, the tool-holder clamp, the tool-holder storage, the tool housing and picking assembly, and the set of tools extraction method fulfill their intended object.

Advantageously, the tool-holder clamp is space-saving axially because it has an axial encumbrance substantially comprised between the tool-holder disc and the end of the gripping handle opposite such tool-holder disc.

Advantageously, the tool-holder clamp is radially space-saving or has a radial encumbrance comparable with tool-holder clamps according to the state of the art because the radial extension of the tool-holder clamp is defined by the dimensions of the centering frame.

According to an advantageous aspect, the tool-holder clamp is structurally easier to make because the identification and centering structure slides on the outer surface of the gripping handle and the centering means are obtained outside the gripping handle.

According to a further advantageous aspect, the tool-holder clamp is mechanically easier to use, because the operator may easily regulate the translation of the identification and centering structure as it is external to the gripping handle. Further, the centering means, being obtained outside the gripping handle, are also manageable without difficulty by the operator.

Advantageously, the tool-holder storage is extremely functional because the engagement of the complementary coupling means is external to the shell body, and only the set of tools is housable in the compartment inside the shell body.

According to an advantageous aspect, the tool housing and picking assembly is practical, because the extraction of the set of tools from the tool-holder storage only takes place following the engagement between the tool-holder disc and the set of tools and after also obtaining the mutual engagement between the centering means and counter-means. However, the coupling between the centering means and counter-means is external to both the gripping handle of the tool-holder clamp and the tool-holder shell.

To the embodiments of the tool-holder clamp, the tool-holder storage, the tool housing and picking assembly and the method for extracting the set of tools according to the invention, a person skilled in the art, in order to meet contingent needs, may make modifications, adaptations and replacements of elements with functionally equivalent ones, without departing from the scope of protection of the following claims. Each of the features described as belonging to a possible embodiment may be obtained independently of the other described embodiments.

1. A tool-holder clamp for picking and depositing a set of tools for a radial press from a tool-holder storage, said tool-holder clamp comprising:
a gripping handle mainly extending along a clamp axis;
a tool-holder disc positioned at one end of the gripping handle and provided with support means suitable for supporting the set of tools in a circular arrangement; and
an identification and centering structure slidingly engaged outside the gripping handle so as to translate along the clamp axis between a retracted position associated with an engagement with a first set of tools, and an advanced position associated with an engagement with a second set of tools having a different axial length with respect to an axial length of the first set of tools,
wherein the identification and centering structure comprises centering means suitable for creating complementary coupling means with respective centering counter-means provided on the tool-holder storage so that, by arranging the identification and centering structure in a position compliant with the length of the set of tools to be picked, the centering means are configured so that an engagement with the respective centering counter-means is obtained, and the tool-holder clamp is made engageable with the set of tools.

2. The tool-holder clamp of claim 1, wherein the identification and centering structure further comprises a ring nut sliding on the gripping handle, and wherein by moving the ring nut on the gripping handle an axial translation of the identification and centering structure is obtained, so as to arrange said identification and centering structure in the retracted or advanced position.

3. The tool-holder clamp of claim 1, wherein the identification and centering structure further comprises a centering frame protruding beyond a radial encumbrance of the tool-holder disc, said centering frame being suitable for resting against a front surface of the radial press to ensure an angular alignment between the set of tools and respective jaws with which the radial press is equipped.

4. The tool-holder clamp of claim 1, wherein the centering means are engageable with the centering counter-means to make the tool-holder clamp suitable for engaging the set of tools so as to axially extract said set of tools from the tool-holder storage.

5. The tool-holder clamp of claim 4, wherein the centering means comprise a centering peg provided with a lowered portion and axially protruding from the identification and centering structure, the lowered portion being engageable with the centering counter-means when the identification and centering structure is in the position compliant with the length of the set of tools to be picked, and wherein the tool-holder clamp is rotatable to release the set of tools from the tool-holder storage, said lowered portion being configured to engage with the centering counter-means during a rotation of said tool-holder clamp.

6. The tool-holder clamp of claim 4, wherein the centering means comprise a centering flange where a pair of holes is obtained, the holes being connected to each other by a groove with a smaller width than that of a diameter of each hole of said pair of holes, wherein said centering means are engageable by the centering counter-means when the identification and centering structure is in the position compliant with the length of the set of tools to be picked, and wherein the tool-holder clamp is rotatable to release the set of tools from the tool-holder storage, said centering means being configured for remaining engaged by the respective centering counter-means during a rotation of said tool-holder clamp.

7. The tool-holder clamp of claim 3, wherein the centering means are made in one piece with the centering frame or are fixed and made integral with said centering frame.

8. A tool-holder storage for tooling a radial press comprising:
a support frame;
at least one set of tools comprising a plurality of blocks having a cross-section in a shape of a circular crown portion, wherein each block of said plurality of blocks is provided with a pin protruding radially outwards, the set of tools being engageable by the tool-holder clamp according to of claim 1; and
a plurality of tool-holder shells fixed to said support frame, wherein each tool-holder shell of said plurality of tool-holder shells is configured to house the set of tools,
wherein each tool-holder shell comprises a substantially cylindrical shell body internally delimiting a compartment where the set of tools is housed, longitudinal slits being obtained in the substantially cylindrical shell body, frontally open and posteriorly ending with a slot inclined by 90° with respect to said longitudinal slits, each longitudinal slit of said longitudinal slits and the respective slot being configured to slidingly accommodate the pin,
and wherein the tool-holder storage further comprises centering counter-means suitable for creating complementary coupling means with respective centering means provided on the identification and centering structure of the tool-holder clamp, in such a way that, by arranging the identification and centering structure in the position compliant with the length of the set of tools to be picked, the centering counter-means are configured to obtain the engagement with the respective centering means and make the tool-holder clamp engageable with the set of tools, said centering counter-means being outside the substantially cylindrical shell body.

9. The tool-holder storage of claim 8, wherein the centering counter-means are engageable with the centering means in such a way that the set of tools is suitable for being engaged by the tool-holder clamp to be extracted axially from the tool-holder storage, and wherein the centering counter-means are fixed and connected to the support frame and/or to the substantially cylindrical shell body.

10. The tool-holder storage of claim 9, wherein the centering counter-means are suitable for cooperating with the respective centering means of the tool-holder clamp, the centering means being engageable with the centering counter-means to make the tool-holder clamp suitable for engaging the set of tools so as to axially extract said set of tools from the tool-holder storage, and comprising a centering peg provided with a lowered portion and axially protruding from the identification and centering structure, the lowered portion being engageable with the centering counter-means when the identification and centering structure is in the position compliant with the length of the set of tools to be picked, wherein the tool-holder clamp is rotatable to release the set of tools from the tool-holder storage, said lowered portion being configured to engage with the centering counter-means during a rotation of said tool-holder clamp,
wherein the centering counter-means comprise a coupling flange where a pair of coupling holes is obtained, the coupling holes being connected to each other by a guide with a smaller width than that of a diameter of each coupling hole of said pair of coupling holes, said centering counter-means being engageable by the centering peg when the identification and centering structure is in the position compliant with the length of the set of tools to be picked, and
wherein the centering counter-means are configured to remain engaged by the centering peg during the rotation of the tool-holder clamp to release the set of tools from the tool-holder storage.

11. The tool-holder storage of claim 9, wherein the centering counter-means are suitable for cooperating with the respective centering means of the tool-holder clamp, the centering means-being engageable with the centering counter-means to make the tool-holder clamp suitable for engaging the set of tools so as to axially extract said set of tools from the tool-holder storage, and comprising a centering flange where a pair of holes is obtained, the holes being connected to each other by a groove with a smaller width than that of a diameter of each hole of said pair of holes, wherein said centering means are engageable by the centering counter-means when the identification and centering structure is in the position compliant with the length of the set of tools to be picked, wherein the tool-holder clamp is rotatable to release the set of tools from the tool-holder storage, said centering means being configured for remaining engaged by the respective centering counter-means during a rotation of said tool-holder clamp,
wherein the centering counter-means comprise a coupling peg provided with a lowered coupling portion, said coupling peg having a greater axial length than the tool-holder shell, the lowered coupling portion being suitable for engaging the respective centering means when the identification and centering structure is in the position compliant with the length of the set of tools to be picked, and
wherein the lowered coupling portion is configured to remain engaged with the centering means during the rotation of the tool-holder clamp to release the set of tools from the tool-holder storage.

12. A tool housing and picking assembly comprising:
a tool-holder clamp for picking and depositing a set of tools for a radial press from a tool-holder storage, said tool-holder clamp comprising:
a gripping handle mainly extending along a clamp axis;
a tool-holder disc positioned at one end of the gripping handle and provided with support means suitable for supporting the set of tools in a circular arrangement; and
an identification and centering structure slidingly engaged outside the gripping handle so as to translate along the clamp axis between a retracted position associated with an engagement with a first set of tools, and an advanced position associated with an engagement with a second set of tools having a different axial length with respect to an axial length of the first set of tools,
wherein the identification and centering structure comprises centering means suitable for creating complementary coupling means with respective centering counter-means provided on the tool-holder storage so that, by arranging the identification and centering structure in a position compliant with the length of the set of tools to be picked, the centering means are configured so that an engagement with the respective centering counter-means is obtained, and the tool-holder clamp is made engageable with the set of tools; and
a tool-holder storage for tooling the radial press comprising:
a support frame;
at least one set of tools comprising a plurality of blocks having a cross-section in a shape of a circular crown portion, wherein each block of said plurality of blocks is provided with a pin protruding radially outwards, the at least one set of tools being engageable by the tool-holder clamp; and
a plurality of tool-holder shells fixed to said support frame, wherein each tool-holder shell of said plurality of tool-holder shells is configured to house the set of tools,
wherein each tool-holder shell comprises a substantially cylindrical shell body internally delimiting a compartment where the set of tools is housed, longitudinal slits being obtained in the substantially cylindrical shell body, frontally open and posteriorly ending with a slot inclined by 90° with respect to said longitudinal slits, each longitudinal slit of said longitudinal slits and the respective slot being configured to slidingly accommodate the pin,
and wherein the tool-holder storage further comprises centering counter-means suitable for creating complementary coupling means with respective centering means provided on the identification and centering structure of the tool-holder clamp, in such a way that, by arranging the identification and centering structure in the position compliant with the length of the set of tools to be picked, the centering counter-means are configured to obtain the engagement with the respective centering means and make the tool-holder clamp engageable with the set of tools, said centering counter-means being outside the substantially cylindrical shell body.

13. A tool housing and picking assembly comprising:
the tool-holder clamp of claim 1; and
a tool-holder storage comprising:
a support frame;
at least one set of tools comprising a plurality of blocks having a cross-section in a shape of a circular crown portion, wherein each block of said plurality of blocks is provided with a pin protruding radially outwards, the set of tools being engageable by the tool-holder clamp; and
a plurality of tool-holder shells fixed to said support frame, wherein each tool-holder shell of said plurality of tool-holder shells is configured to house the set of tools,
wherein each tool-holder shell comprises a substantially cylindrical shell body internally delimiting a compartment where the set of tools is housed, longitudinal slits being obtained in the substantially cylindrical shell body, frontally open and posteriorly ending with a slot inclined by 90° with respect to said longitudinal slits, each longitudinal slit of said longitudinal slits and the respective slot being configured to slidingly accommodate the pin,
wherein the tool-holder storage further comprises centering counter-means suitable for creating complementary coupling means with respective centering means provided on the identification and centering structure of the tool-holder clamp—in such a way that, by arranging the identification and centering structure in the position compliant with the length of the set of tools to be picked, the centering counter-means are configured to obtain the engagement with the respective centering means and make the tool-holder clamp engageable with the set of tools, said centering counter-means being outside the substantially cylindrical shell body,
wherein the centering counter-means are engageable with the centering means in such a way that the set of tools is suitable for being engaged by the tool-holder clamp to be extracted axially from the tool-holder storage, wherein the centering counter-means are fixed and connected to the support frame and/or to the substantially cylindrical shell body,
wherein the centering counter-means are suitable for cooperating with the respective centering means of the tool-holder clamp, the centering means being engageable with the centering counter-means to make the tool-holder clamp suitable for engaging the set of tools so as to axially extract said set of tools from the tool-holder storage and comprising a centering flange where a pair of holes is obtained, the holes being connected to each other by a groove with a smaller width than that of a diameter of each hole of said pair of holes, wherein said centering means are engageable by the centering counter-means when the identification and centering structure is in the position compliant with the length of the set of tools to be picked,
wherein the tool-holder clamp is rotatable to release the set of tools from the tool-holder storage, said centering means being configured for remaining engaged by the respective centering counter-means during a rotation of said tool-holder clamp,
wherein the centering counter-means comprise a coupling peg provided with a lowered coupling portion, said coupling peg having a greater axial length than the tool-holder shell, the lowered coupling portion being suitable for engaging the respective centering means when the identification and centering structure is in the position compliant with the length of the set of tools to be picked, and
wherein the lowered coupling portion is configured to remain engaged with the centering means during the rotation of the tool-holder clamp to release the set of tools from the tool-holder storage.

14. A method for extracting a set of tools from a tool-holder storage, the method comprising:
providing a tool housing and picking assembly comprising:
a tool-holder clamp for picking and depositing a set of tools for a radial press from a tool-holder storage, said tool-holder clamp comprising:
a gripping handle mainly extending along a clamp axis;
a tool-holder disc positioned at one end of the gripping handle and provided with support means suitable for supporting the set of tools in a circular arrangement; and
an identification and centering structure slidingly engaged outside the gripping handle so as to translate along the clamp axis between a retracted position associated with an engagement with a first set of tools, and an advanced position associated with an engagement with a second set of tools having a different axial length with respect to an axial length of the first set of tools,
wherein the identification and centering structure comprises centering means suitable for creating complementary coupling means with respective centering counter-means provided on the tool-holder storage so that, by arranging the identification and centering structure in a position compliant with the length of the set of tools to be picked, the centering means are configured so that an engagement with the respective centering counter-means is obtained, and the tool-holder clamp is made engageable with the set of tools; and
a tool-holder storage for tooling the radial press comprising:
a support frame;
at least one set of tools comprising a plurality of blocks having a cross-section in a shape of a circular crown portion, wherein each block of said plurality of blocks is provided with a pin protruding radially outwards, the at least one set of tools being engageable by the tool-holder clamp; and
a plurality of tool-holder shells fixed to said support frame, wherein each tool-holder shell of said plurality of tool-holder shells is configured to house the set of tools,
wherein each tool-holder shell comprises a substantially cylindrical shell body internally delimiting a compartment where the set of tools is housed, longitudinal slits being obtained in the substantially cylindrical shell body, frontally open and posteriorly ending with a slot inclined by 90° with respect to said longitudinal slits, each longitudinal slit of said longitudinal slits and the respective slot being configured to slidingly accommodate the pin,
and wherein the tool-holder storage further comprises centering counter-means suitable for creating complementary coupling means with respective centering means provided on the identification and centering structure of the tool-holder clamp, in such a way that, by arranging the identification and centering structure in the position compliant with the length of the set of tools to be picked, the centering counter-means are configured to obtain the engagement with the respective centering means and make the tool-holder clamp engageable with the set of tools, said centering counter-means being outside the substantially cylindrical shell body;
grasping the tool-holder clamp and moving said tool-holder clamp close to the tool-holder storage to pick the set of tools with a desired axial length for carrying out pressing operations;
arranging the identification and centering structure in the retracted position for picking the first set of tools, or in the advanced position for picking the second set of tools;
engaging the tool-holder disc with the set of tools to be picked;
engaging the centering means of the tool-holder clamp with the respective centering counter-means of the tool-holder storage;
rotating the tool-holder clamp, so that the pin of each block moves along the slot until the pin is aligned with the respective longitudinal slit; and
pulling the tool-holder clamp so that a movement of each pin along the longitudinal slit allows an extraction of the set of tools from the tool-holder shell.

15. The method of claim 14, wherein the centering counter-means are engageable with the centering means in such a way that the set of tools is suitable for being engaged by the tool-holder clamp to be extracted axially from the tool-holder storage, wherein the centering counter-means are fixed and connected to the support frame and/or to the substantially cylindrical shell body,
wherein the centering counter-means are suitable for cooperating with the respective centering means of the tool-holder clamp, the centering means being engageable with the centering counter-means to make the tool-holder clamp suitable for engaging the set of tools so as to axially extract said set of tools from the tool-holder storage, and comprising a centering peg provided with a lowered portion and axially protruding from the identification and centering structure, the lowered portion being engageable with the centering counter-means when the identification and centering structure is in the position compliant with the length of the set of tools to be picked, wherein the tool-holder clamp is rotatable to release the set of tools from the tool-holder storage, said lowered portion being configured to engage with the centering counter-means during a rotation of said tool-holder clamp,
wherein the centering counter-means comprise a coupling flange where a pair of coupling holes is obtained, the coupling holes being connected to each other by a guide with a smaller width than that of a diameter of each coupling hole of said pair of coupling holes, said centering counter-means being engageable by the centering peg when the identification and centering structure is in the position compliant with the length of the set of tools to be picked, and
wherein the centering counter-means are configured to remain engaged by the centering peg during the rotation of the tool-holder clamp to release the set of tools from the tool-holder storage,
the method further comprising:
creating the engagement between the centering means of the tool-holder clamp and the respective centering counter-means of the tool-holder storage, by inserting the centering peg into a first coupling hole of the pair of coupling holes; and
rotating the tool-holder clamp, so that the lowered portion having a smaller cross section than a cross section of the centering peg slides along the guide and allows the centering peg to reach a second coupling hole of the pair of coupling holes, wherein an angular distance traveled by the tool-holder clamp to take the centering peg from the first coupling hole to the second coupling hole coincides with an angular distance traveled by the pin of each block to slide along the slot and align axially with the respective longitudinal slit.

16. The method of claim 14, wherein the centering counter-means are engageable with the centering means in such a way that the set of tools is suitable for being engaged by the tool-holder clamp to be extracted axially from the tool-holder storage, and wherein the centering counter-means are fixed and connected to the support frame and/or to the substantially cylindrical shell body,
wherein the centering counter-means are suitable for cooperating with the respective centering means of the tool-holder clamp, the centering means being engageable with the centering counter-means to make the tool-holder clamp suitable for engaging the set of tools so as to axially extract said set of tools from the tool-holder storage, and comprising a centering flange where a pair of holes is obtained, the holes being connected to each other by a groove with a smaller width than that of a diameter of each hole of said pair of holes, wherein said centering means are engageable by the centering counter-means when the identification and centering structure is in the position compliant with the length of the set of tools to be picked, wherein the tool-holder clamp is rotatable to release the set of tools from the tool-holder storage, said centering means being configured for remaining engaged by the respective centering counter-means during a rotation of said tool-holder clamp,
wherein the centering counter-means comprise a coupling peg provided with a lowered coupling portion, said coupling peg having a greater axial length than the tool-holder shell, the lowered coupling portion being suitable for engaging the respective centering means when the identification and centering structure is in the position compliant with the length of the set of tools to be picked, and
wherein the lowered coupling portion is configured to remain engaged with the centering means during the rotation of the tool-holder clamp to release the set of tools from the tool-holder storage,
the method further comprising:
creating the engagement between the centering means of the tool-holder clamp and the respective centering counter-means of the tool-holder storage, by inserting the coupling peg into a first hole of the pair of holes; and
rotating the tool-holder clamp so that the lowered coupling portion, having a smaller cross section than a cross section of the coupling peg, slides along the groove and allows the coupling peg to reach a second hole of the pair of holes, wherein an angular distance travelled by the tool-holder clamp to take the coupling peg from the first hole to the second hole coincides with an angular distance traveled by the pin of each block to slide along the slot and align axially with the respective longitudinal slit.
